(19) United States
(12) Patent Application Publication
(10) Pub. No.: US 2017/0308469 A1
(43) Pub. Date: Oct. 26, 2017

(54) Resource Processing Method and Device for Multi-controller System

(71) Applicant: ZTE Corporation, Shenzhen (CN)

(72) Inventors: Huang LIU, Shenzhen (CN); Qi XU, Shenzhen (CN); Changjiang YANG, Shenzhen (CN)

(21) Appl. No.: 15/521,383

(22) PCT Filed: Feb. 11, 2015
(86) PCT No.: PCT/CN2015/072799

§ 371 Date: Apr. 24, 2017

(30) Foreign Application Priority Data
Oct. 22, 2014 (CN) 201410568338.7

(51) Int. Cl. G06F 12/0806; H04L 12/24; G06F 12/02; G06F 11/20; G06F 11/14; H04L 12/26; G06F 11/07

(52) U.S. Cl. CPC G06F 12/0806; H04L 43/10; H04L 41/0645; G06F 11/0724; G06F 11/2028; G06F 11/1425; G06F 12/02

(57) ABSTRACT

A resource processing method and device for a multi-controller system are provided. The method includes that: when a controller in the multi-controller system may not sense existence of a peer controller, the controller judges whether the peer controller loads a first resource pool according to a first use tag stored in the first resource pool previously loaded by the peer controller.

### TECHNICAL FIELD

The present disclosure relates to the field of communications, and more particularly to a resource processing method and device for a multi-controller system.

### BACKGROUND

A multi-controller system with a shared backend memory includes multiple controllers. Under a normal condition, the controllers judge states of one another through a detection mechanism (for example, a heartbeat signal), and when a certain or some controllers are turned off or quit, the other controllers may take over storage pool resources running thereon to ensure normal running of the system. If communication between the controllers is interrupted or gets abnormal, the controllers may not sense existence of the peers to cause split-brain. Descriptions will be made below with a double-controller system as an example. FIG. 1 is a schematic diagram of occurrence of a split-brain condition in a double-controller system according to a related technology. As shown in FIG. 1, double controllers consider that the peers have been normally turned off or quitted, and the double controllers are further triggered to take over the same backend storage object (such as a storage pool resource). Use of storage objects is usually required to be mutually exclusive, and in a split-brain scenario, the storage object may be simultaneously taken over by the double controllers for use to be damaged.

In a existing multi-controller system, a method of adding a third-party node or a quorum disk is usually adopted to assist in judging whether split-brain occurs or not and avoid double controllers simultaneously competing for a storage pool resource.

FIG. 2 is a schematic diagram of judging whether a split-brain condition occurs or not in a double-controller system by a third-party node according to the related technology. As shown in FIG. 2, when communication between double controllers is interrupted, the double controllers may query a third-party node, and the third-party node tells them whether their peer nodes are abnormal or not. However, adding the third-party node may not absolutely ensure judgment accuracy, for example, an abnormality of a channel between the third-party node and equipment may also cause a misjudgment, and cost in addition of the third-party node is relatively high.

FIG. 3 is a schematic diagram of judging whether a split-brain condition occurs in a double-controller system or not by a quorum disk according to the related technology. However, a quorum disk manner wastes a hard disk on one hand. On the other hand, the hard disk has no redundancy backup, and when the quorum disk fails, a detection mechanism may fail.

For the problems of high cost and existence of a failure probability of a split-brain detection mechanism in a multi-controller system, there is yet no effective solution.

### SUMMARY

In the embodiments of the present disclosure, resource processing methods and devices for a multi-controller system are provided, to solve the problems of high cost and existence of a failure probability of a split-brain detection mechanism in the multi-controller system.

According to an embodiment of the present disclosure, a resource processing method for a multi-controller system is provided, which may include that: a controller in the multi-controller system may not sense existence of a peer controller; and the controller judges whether the peer controller loads a first resource pool or not according to a first use tag stored in the first resource pool previously loaded by the peer controller, and the first use tag may be configured to identify whether the peer controller loads the first resource pool or not.

In certain embodiments, before the step that the controller judges whether the peer controller loads the first resource pool or not according to the first use tag, the method may further include that: each controller in the multi-controller system regularly writes the first use tag into a respectively loaded resource pool, and the first use tag may be configured to identify whether the controller loads the resource pool of the controller or not.

In certain embodiments, under the condition that the controller judges that the peer controller does not load the first resource pool according to the first use tag, the method may further include that: the controller writes a second use tag indicating the controller to load the first resource pool into the first resource pool, and loads the first resource pool.

In certain embodiments, after the step that the controller writes the second use tag indicating the controller to load the first resource pool into the first resource pool, the method may further include that: the controller judges whether the peer controller loads the first resource pool or not according to the first use tag in the first resource pool, and under the condition that a judgment result is YES, the controller does not load the first resource pool, and clears the second use tag.

In certain embodiments, the step that the controller judges whether the peer controller loads the first resource pool or not according to the first use tag stored in the first resource pool may include that: under the condition that the first use tag includes identification information indicating whether the controller loads the resource pool or not, the controller determines whether the peer controller loads the first resource pool or not according to a value of the identification information; and/or, under the condition that the first use tag includes the identification information indicating whether the controller loads the resource pool or not and writes a timestamp of the identification information, the controller judges whether the timestamp changes or not within a preset time length, determines that the peer controller loads the first resource pool if the timestamp changes, otherwise determines that the peer controller does not load the first resource pool.

In certain embodiments, the step that each controller regularly writes the first use tag into the respectively loaded resource pool may include that: each controller writes the first use tag into a corresponding logic area in the respectively loaded resource pool, and the resource pool may be logically divided into n areas, each area may correspond to a controller, and the first use tag written into each area may represent a resource pool loading condition of the controller corresponding to the area.

According to another embodiment of the present disclosure, a resource processing device for a multi-controller system is further provided, which may be located in a controller, the device including: a sensing module, configured to sense whether a peer controller exists or not; and a judgment module, configured to, under the condition that the sensing module may not sense existence of the peer controller, judge whether the peer controller loads a first resource pool or not according to a first use tag stored in the first resource pool previously loaded by the peer controller.

In certain embodiments, the device may further include: a first writing module, configured to regularly write the first use tag into the resource pool loaded by the controller, and the first use tag may be configured to identify whether the controller loads the resource pool of the controller or not.

In certain embodiments, the device may further include: a second writing module, configured to, under the condition that the judgment module judges that the peer controller does not load the first resource pool, write a second use tag indicating the controller to load the first resource pool into the first resource pool, and load the first resource pool.

In certain embodiments, the second writing module may further be configured to, after the second use tag is written, judge whether the peer controller loads the first resource pool or not according to the first use tag in the first resource pool, and under the condition that a judgment result is YES, not load the first resource pool and clear the second use tag.

In certain embodiments, the judgment module may include: a first judgment unit, configured to, under the condition that the first use tag includes identification information indicating whether the controller loads the resource pool or not, determine whether the peer controller loads the first resource pool or not according to a value of the identification information; and/or, a second judgment unit, configured to, under the condition that the first use tag includes the identification information indicating whether the controller loads the resource pool or not and writes a timestamp of the identification information, judge whether the timestamp changes or not within a preset time length, determine that the peer controller loads the first resource pool if the timestamp changes, otherwise determine that the peer controller does not load the first resource pool.

In certain embodiments, the first writing module may include: a logic module, configured to write the first use tag into a corresponding logic area in the resource pool loaded by the controller, and the resource pool may be logically divided into n areas, each area may correspond to a controller, and the first use tag written into each area may represent a resource pool loading condition of the controller corresponding to the area.

According to the present disclosure, the controller in the multi-controller system may not sense existence of the peer controller; and the controller judges whether the peer controller loads the first resource pool or not according to the first use tag stored in the first resource pool previously loaded by the peer controller, and the first use tag identifying whether the peer controller loads the first resource pool or not. The problems of high cost and existence of a failure probability of a split-brain detection mechanism in the multi-controller system are solved, whether a split-brain state occurs in the multi-controller system or not is detected under the condition of not adding any third-party equipment and not adding any dedicated quorum disk, cost is reduced, and detection reliability and stability are improved.

### BRIEF DESCRIPTION OF THE DRAWINGS

The drawings described here are adopted to provide a further understanding to the present disclosure, and form a part of the present disclosure. Schematic embodiments of the present disclosure and descriptions thereof are adopted to explain the present disclosure.

FIG. 1 is a schematic diagram of occurrence of a split-brain condition in a double-controller system according to the related technology.

FIG. 2 is a schematic diagram of judging whether a split-brain condition occurs or not in a double-controller system by a third-party node according to the related technology.

FIG. 3 is a schematic diagram of judging whether a split-brain condition occurs in a double-controller system or not by a quorum disk according to the related technology.

FIG. 4 is a flowchart of a resource processing method for a multi-controller system according to an embodiment of the present disclosure.

FIG. 5 is a structure block diagram of a resource processing device for a multi-controller system according to an embodiment of the present disclosure.

FIG. 6 is a normal running diagram of a resource processing method for a double-controller system according to an embodiment of the present disclosure.

FIG. 7a is a schematic diagram of a Redundant Array of Independent Disks (RAID) of a marked area of a storage pool in a resource processing method for a double-controller system according to an embodiment of the present disclosure.

FIG. 7b is another schematic diagram of a RAID of a marked area of a storage pool in a resource processing method for a double-controller system according to an embodiment of the present disclosure.

FIG. 8 is a schematic diagram of a split-brain state in a resource processing method for a double-controller system according to an embodiment of the present disclosure.

FIG. 9a is a schematic diagram of a marked area of a storage pool in a split-brain state in a resource processing method for a double-controller system according to an alternative embodiment of the present disclosure.

FIG. 9b is another schematic diagram of a marked area of a storage pool in a split-brain state in a resource processing method for a double-controller system according to an embodiment of the present disclosure.

FIG. 10 is a first flowchart of a resource processing method for a double-controller system according to an embodiment of the present disclosure.

FIG. 11 is a second flowchart of a resource processing method for a double-controller system according to an embodiment of the present disclosure.

FIG. 12 is a flowchart of split-brain detection according to an alternative embodiment of the present disclosure.

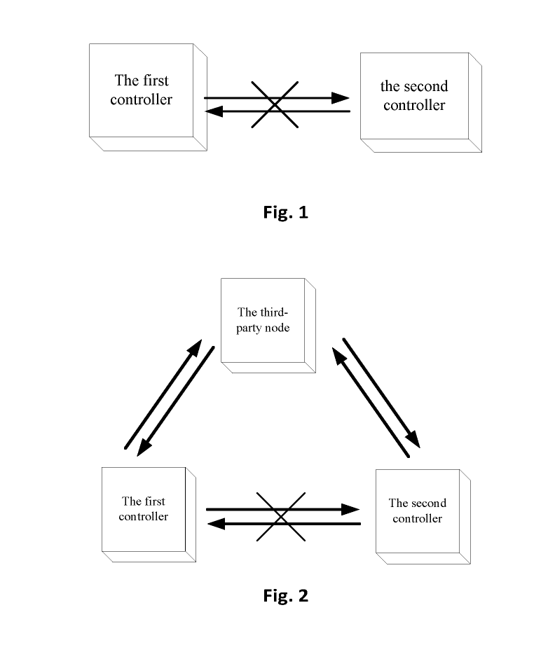

### DETAILED DESCRIPTION OF THE EMBODIMENTS

It is important to note that embodiments in the present disclosure and characteristics in the embodiments may be combined. The present disclosure will be described below in detail with reference to the drawings and embodiments.

Steps shown in the flowcharts of the drawings may be executed in a computer system, such as a group of computers, capable of executing instructions, and moreover, although logic sequences are shown in the flowcharts, the shown or described steps may be executed in sequences different from the sequences shown here under some conditions.

A multi-controller system in the following embodiments includes two or more than two controllers, and a peer controller may represent part or all of other controllers, except a controller, in the multi-controller system. For example, the peer controller may be one controller, and may also be multiple controllers.

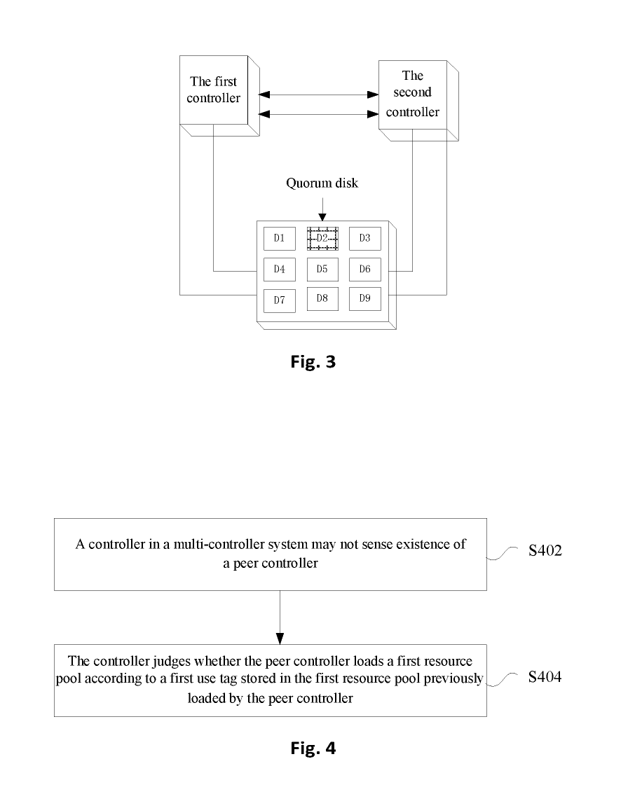

The embodiments provide a resource processing method for a multi-controller system. FIG. 4 is a flowchart of a resource processing method for a multi-controller system according to an embodiment of the present disclosure, and as shown in FIG. 4, the flow includes the following steps S402 to S404.

At Step S402: a controller in a multi-controller system may not sense existence of a peer controller.

At Step S404: the controller judges whether the peer controller loads a first resource pool or not according to a first use tag stored in the resource pool previously loaded by the peer controller, and the first use tag identifying whether the peer controller loads the first resource pool or not. “Before” in the step refers to before the state that the controller may not sense the peer controller, and for convenient description, the resource pool loaded by the peer controller is described with the first resource pool in the embodiments, and “first” is only a mark and not intended to limit the resource pool.

By each of the abovementioned steps, the use tag in the resource pool may be read to determine whether the peer party is still being loading the resource pool or not. The use tag is stored in the resource pool, and then no additional node and quorum disk are required to be added, so that the problems of high cost and existence of a failure probability of a split-brain detection mechanism in the multi-controller system are solved, cost is reduced, and detection reliability is improved.

In an alternative embodiment, each controller may regularly write the first use tag into a respectively loaded resource pool at a certain time, and for example, may write before Step S404. The first use tag written into the respectively loaded resource pool by each controller is configured to identify whether the controller loads the resource pool of the controller.

In Step S404, the controller judges whether the peer controller loads the first resource pool or not according to the first use tag stored in the resource pool loaded by the peer controller, and there are two judgment results of the controller. In an alternative embodiment, if the controller judges that the peer controller does not load the first resource pool, the controller writes a second use tag indicating the controller to load the first resource pool into the first resource pool, and loads the first resource pool. Of course, the controller may also notify another controller or equipment of loading the first resource pool.

In certain embodiments, after judging that the peer controller does not load the first resource pool according to the first use tag stored in the first resource pool, the controller writes the second use tag into the first resource pool, and simultaneously loads the first resource pool. The second use tag may indicate that the resource pool has been loaded, and may prevent the other controller from loading the first resource pool again.

In certain embodiments, after writing the second use tag indicating the controller to load the first resource pool into the first resource pool, the controller may further judge whether the peer controller may load the first resource pool or not. For example, the controller may judge whether the peer controller loads the first resource pool or not according to the first use tag in the first resource pool, and under the condition that a judgment result is YES, the controller does not load the first resource pool, and clears the second use tag.

By the manner of loading or not loading the first resource pool after re-judgment, mistaken detection of a split-brain state may be avoided to a certain extent, and the detection reliability is improved.

For how to judge whether the peer controller loads the first resource pool or not by the controller according to the first use tag stored in the first resource pool, there are multiple implementation modes. Three implementation modes will be described below.

In the first implementation mode, the first use tag includes identification information indicating whether the controller loads the resource pool or not, and the controller determines whether the peer controller loads the first resource pool or not according to a value of the identification information.

For example, in a double-controller system, the identification information indicating whether the controller loads the resource pool is a Boolean value, when the identification information stored in the first resource pool is 1, it is indicated that the peer controller loads the first resource pool, and when the identification information stored in the first resource pool is 0, it is indicated that the peer controller does not load the first resource pool.

By adopting the method, it is easier to detect split-brain.

In the second implementation mode, the first use tag includes the identification information indicating whether the controller loads the resource pool or not and writes a timestamp of the identification information, and the controller judges whether the timestamp changes or not within a preset time length, determines that the peer controller loads the first resource pool if the timestamp changes, otherwise determines that the peer controller does not load the first resource pool.

In the third implementation mode, the first use tag includes the identification information indicating whether the controller loads the resource pool or not and the timestamp of the identification information is written, the controller determines whether the peer controller loads the first resource pool or not according to the value of the identification information, and if the controller determines that the peer controller loads the first resource pool according to the value of the identification information, the controller further judges whether the timestamp changes or not within the preset time length, determines that the peer controller loads the first resource pool if the timestamp changes, otherwise determines that the peer controller does not load the first resource pool. Or, if the controller determines that the peer controller does not load the first resource pool according to the value of the identification information, the controller further judges whether the timestamp changes or not within the preset time length, determines that the peer controller loads the first resource pool if YES, otherwise determines that the peer controller does not load the first resource pool.

By adopting the method, dual judgments are made to the identification information and the timestamp, cost in detection about whether split-brain occurs in the multi-controller system or not is reduced, and the detection reliability is further improved.

The judgment modes are modes of judging the first use tag, and the modes may also be used when the second use tag is judged.

For a writing manner for the first use tag, in an alternative embodiment, the operation that each controller regularly writes the first use tag into the respectively loaded resource pool includes that: each controller writes the first use tag into a corresponding logic area in the respectively loaded resource pool, and the resource pool is logically divided into n areas, each area corresponds to a controller, and the first use tag written into each area represents a resource pool loading condition of the controller corresponding to the area.

The method that each controller writes the first use tag into the corresponding logic area in the respectively loaded resource pool is adopted, the n areas are obtained by logically dividing the resource pool, and the n areas inherit characteristics of the resource pool, so that n controllers may determine whether split-brain occurs or not in a current state by judging the first use tags in the n areas, and data damage caused by simultaneous loading of multiple controllers over a certain area is avoided.

The embodiments further provide a device. The device corresponds to the method in the embodiments, and what has been described will not be elaborated. Modules or units in the device may be codes which are stored in a controller and may be run by a processor, and may also be implemented in another manner, and examples will not be listed one by one.

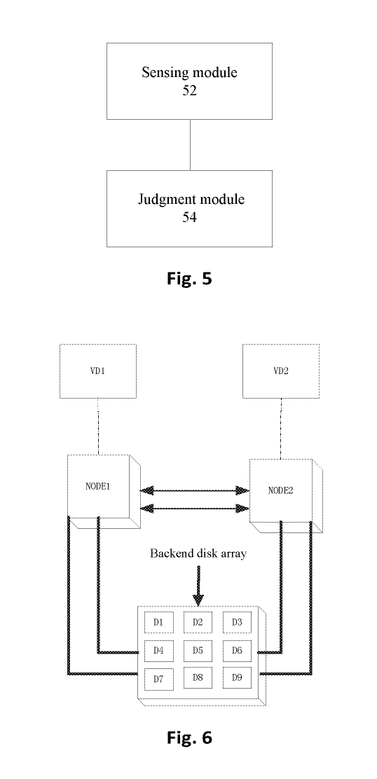

According to an embodiment of the present disclosure, a resource processing device for a multi-controller system is further provided. FIG. 5 is a structure block diagram of a resource processing device for a multi-controller system according to an embodiment of the present disclosure, and as shown in FIG. 5, the device includes a sensing module 52 and a judgment module 54.

The sensing module 52 is configured to sense whether a peer controller exists or not; and

The judgment module 54 is configured to, under the condition that the sensing module 52 may not sense existence of the peer controller, judge whether the peer controller loads a first resource pool or not according to a first use tag stored in the first resource pool previously loaded by the peer controller.

By each of the abovementioned modules, the use tag in the resource pool may be read to determine whether the peer party is still being loading the resource pool or not. The use tag is stored in the resource pool, and then no additional node and quorum disk are required to be added, so that the problems of high cost and existence of a failure probability of a split-brain detection mechanism in the multi-controller system are solved, cost is reduced, and detection reliability is improved.

In certain embodiments, each controller may regularly write the first use tag into a respectively loaded resource pool at a certain time. For example, the device may further include: a first writing module, configured to regularly write the first use tag into the resource pool loaded by the controller, and the first use tag identifying whether the controller loads the resource pool of the controller or not.

There are two judgment results of the judgment module 54. In certain embodiments, the device further includes a second writing module.

The second writing module is configured to, under the condition that the judgment module 54 judges that the peer controller does not load the first resource pool, write a second use tag indicating the controller to load the first resource pool into the first resource pool, and load the first resource pool. Of course, the device may also adopt a manner of notifying another controller or equipment of loading the first resource pool.

In another embodiment, after the judgment module 54 judges that the peer controller does not load the first resource pool according to the first use tag stored in the first resource pool, the second writing modules writes a second use tag into the first resource pool, and simultaneously load the first resource pool. The second use tag may indicate that the resource pool has been loaded, and may prevent the other controller from loading the first resource pool again.

In another embodiment, a further judgment may also be made, the second writing module is further configured to, after the second use tag is written, judge whether the peer controller loads the first resource pool or not according to the first use tag in the first resource pool, and under the condition that a judgment result is YES, not load the first resource pool and clear the second use tag.

By the manner that the second writing modules loads or does not load the first resource pool after re-judgment, mistaken detection of a split-brain state may be avoided to a certain extent, and the detection reliability is improved.

For how to judge whether the peer controller loads the first resource pool or not by the judgment module 54 according to the first use tag stored in the first resource pool, there are multiple implementation modes. Three alternative implementation modes therein will be described below.

In the first implementation mode, the judgment module 54 includes as first judgment unit, and the first judgment unit is configured to, under the condition that the first use tag includes identification information indicating whether the controller loads the resource pool or not, determine whether the peer controller loads the first resource pool or not according to a value of the identification information.

For example, in a double-controller system, the identification information indicating whether the controller loads the resource pool is a Boolean value, when the first judgment unit reads the identification information stored in the first resource pool to be 1, it is indicated that the peer controller loads the first resource pool, and when the first judgment unit reads the identification information stored in the first resource pool to be 0, it is indicated that the peer controller does not load the first resource pool.

By virtue of the first judgment unit, it is easier to detect split-brain.

In the second implementation mode, the judgment module 54 includes a second judgment unit, and the second judgment unit is configured to, under the condition that the first use tag includes the identification information indicating whether the controller loads the resource pool or not and writes a timestamp of the identification information, judge whether the timestamp changes or not within a preset time length, determine that the peer controller loads the first resource pool if YES, otherwise determine that the peer controller does not load the first resource pool.

In the third implementation mode, the judgment module 54 includes the first judgment unit and the second judgment unit, the first judgment unit is configured to, under the condition that the first use tag includes the identification information indicating whether the controller loads the resource pool or not and the timestamp of the identification information is written, determine whether the peer controller loads the first resource pool or not according to the value of the identification information, and if the first judgment unit determines that the peer controller loads the first resource pool according to the value of the identification information, the second judgment unit further judges whether the timestamp changes or not within the preset time length, determines that the peer controller loads the first resource pool if YES, otherwise determines that the peer controller does not load the first resource pool. Or, if the first judgment unit determines that the peer controller does not load the first resource pool according to the value of the identification information, the second judgment unit further judges whether the timestamp changes or not within the preset time length, determines that the peer controller loads the first resource pool if YES, otherwise determines that the peer controller does not load the first resource pool.

By dual judgments made to the identification information and the timestamp by the first judgment unit and the second judgment unit respectively, cost in detection about whether split-brain occurs in the multi-controller system or not is reduced, and the detection reliability is further improved.

The judgment modes are modes of judging the first use tag, and the modes may also be used when the second use tag is judged.

For a writing manner for the first use tag, in an alternative embodiment, the writing module includes: a logic module, configured to write the first use tag into a corresponding logic area in the respectively loaded resource pool, and the resource pool is logically divided into n areas, each area corresponds to a controller, and the first use tag written into each area represents a resource pool loading condition of the controller corresponding to the area.

By virtue of the logic module, each controller writes the first use tag into the corresponding logic area in the respectively loaded resource pool is adopted, the n areas are obtained by logically dividing the resource pool, and the n areas inherit characteristics of the resource pool, so that n controllers may determine whether split-brain occurs or not in a current state by judging the first use tags in the n areas, and data damage caused by simultaneous loading of multiple controllers over a certain area is avoided.

Descriptions will be made below with a double-controller system as an example with reference to an alternative embodiment.

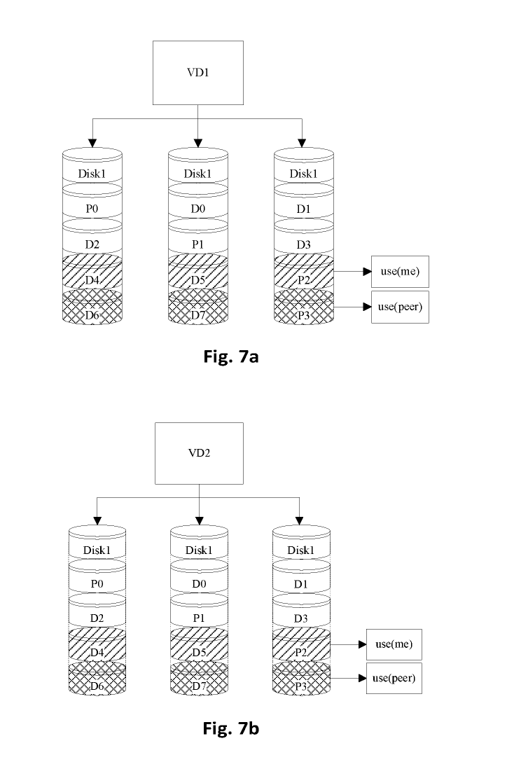

A controller is a node, and descriptions will be made below with nodes instead of controllers. Since a minimum unit for which controllers in a multi-controller system compete is a storage pool Virtual Disk (VD), descriptions will be made below with VDs instead of resource pools. FIG. 6 is a normal running diagram of a resource processing method for a double-controller system according to an alternative embodiment of the present disclosure. As shown in FIG. 6, two controllers in double controllers are node1 and node2 respectively, and a storage pool vd1 runs on node1, and a storage pool vd2 runs on node2. FIG. 7a and FIG. 7b are schematic diagrams of a RAID of a marked area of a storage pool in a resource processing method for a double-controller system according to an alternative embodiment of the present disclosure respectively. As shown in FIG. 7a and FIG. 7b, vd1 and vd2 are both storage pools of raid5, and each storage pool is logically divided into two areas: use(me) and use(peer), to judge whether split-brain currently occurs or not to prevent double-end loading of the storage pool, and since being obtained by logically dividing the storage pool, the two areas inherently have raid characteristics.

Competition of the nodes node1 and node2 for a resource of the storage pool vd2 in case of split-brain will be described below with node1 as a first perspective, and it is indicated that node1 loads the storage pool vd2, that is, node1 is alive, when use(me) is 1, and it is indicated that node2 loads the storage pool vd2, that is, it is indicated that node2 is alive, when use(peer) is 1.

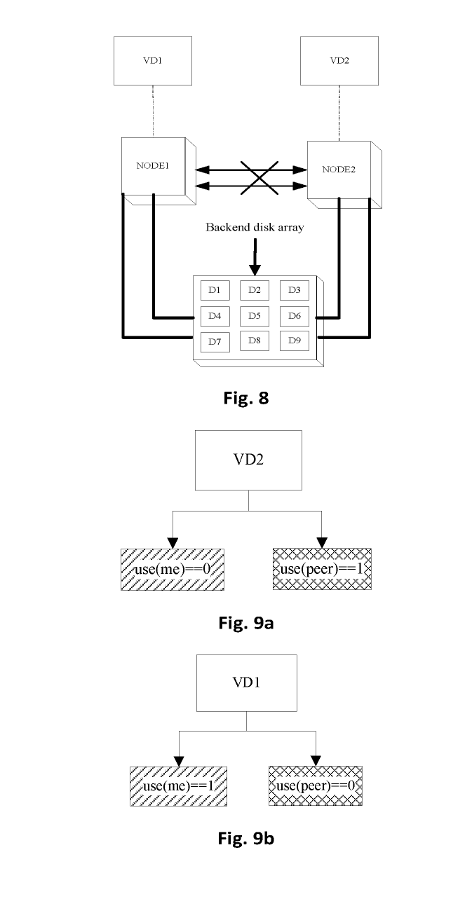

In an embodiment, FIG. 8 is a schematic diagram of a split-brain state in a resource processing method for a double-controller system according to an embodiment of the present disclosure. As shown in FIG. 8, node1 and node2 have been both powered on at this time, node1 may not sense existence of node2, both of the nodes node1 and node2 regularly write a use tag 1 into use(me) areas of storage pools running thereon and write a timestamp of the use tag 1 to ensure that the storage pools running on the nodes are not loaded by the peer nodes and the nodes are alive before the use tag 1 is written next time, and a time interval between twice writing of the use tag 1 is called as a keep-alive time.

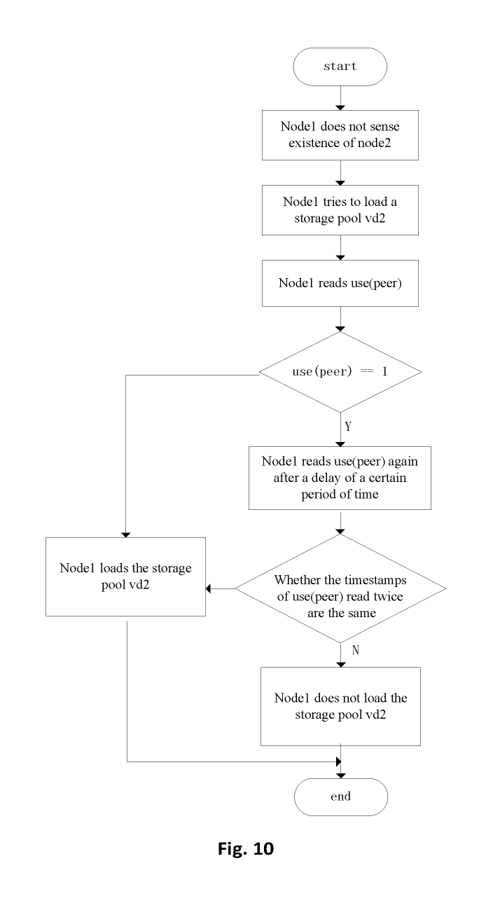

FIG. 9a and FIG. 9b are schematic diagrams of a marked area of a storage pool in a split-brain state in a resource processing method for a double-controller system according to an embodiment of the present disclosure respectively. As shown in FIG. 9a and FIG. 9b, from node1 as the first prospective, values of use(me) and use(peer) corresponding to the storage pool vd1 are: (1,0) respectively at this time, and it is indicated that node1 is being loading the storage pool vd1; values of use(me) and use(peer) corresponding to vd2 are: (0,1) respectively, and it is indicated that node2 is being loading the storage pool vd2; and at this time, node1 may take over the storage pool running on node2, that is, node1 may take over the storage pool vd2.

Specifically, FIG. 10 is a first flowchart of a resource processing method for a double-controller system according to an alternative embodiment of the present disclosure. As shown in FIG. 10, when node1 loads the storage pool vd2, the use(peer) tag of vd2 is read at first, it is found that the value is 1, and the tag 1 indicates that node2 may have been powered off or may have loaded vd2; at this time, the use(peer) tag may be read again after a delay of a certain period of time (the time should be longer than the keep-alive time), it is found that use(peer) is 1 and the keep-alive timestamp is changing, it is indicated that the storage pool vd2 has been loaded on the node node2 and split-brain occurs, and then the node node1 is not required to load vd2, so that a storage pool data error caused by double-end loading of the storage pool vd2 is successfully prevented.

In another embodiment, there exist the following two conditions, and similar processing manners are adopted for the two conditions.

the condition one: if node1 has been powered on, the storage pool vd1 is successfully loaded by node1, node2 is not powered on, node1 may not sense existence of node2, node1 is required to take over the storage pool vd2 running on node2, node2 is powered on, node2 is required to load the storage pool vd2 running on node2, and then split-brain occurs.

the condition two: the double controller nodes are sequentially powered on or simultaneously powered on, if node1 has been powered on, the storage pool vd1 is successfully loaded by node1, node2 is not powered on, node1 does not sense existence of node2, node1 is required to take over the storage pool vd2 running on node2, node2 is powered on at this time, node2 is required to load the storage pool vd2 running on node2, and then split-brain occurs, or when node1 and node2 are simultaneously powered on, split-brain occurs.

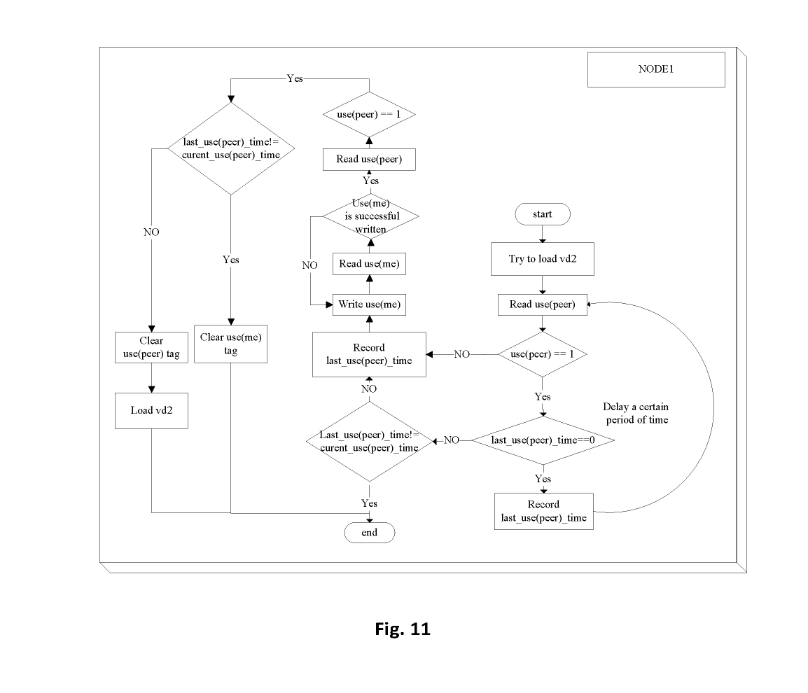

FIG. 11 is a second flowchart of a resource processing method for a double-controller system according to an embodiment of the present disclosure. As shown in FIG. 11, the use(me) and use(peer) tags of vd2 may have two combinations (0,1) or (0,0). At first, the combination (0,0) is considered, (0,0) indicates that the storage pool runs on node2, node2 is normally powered off, and its use(peer) tag has been cleared. Specific implementation is as follows: when the node node1 loads the storage pool vd2, the use(peer) tag is read at first, and is found to be 0, it is indicated that node2 is not alive, use(me) is written to be 1, whether use(me) is successfully written or not is checked, use(peer) is read at the same time, if use(peer) is 1, it is indicated that split-brain occurs, node2 is required to load the storage pool vd2, and node1 clears the use(me) tag, and does not load the storage pool vd2. If the combination of use(me) and use(peer) of vd2 is (0,1), (0,1) indicates that the storage pool runs on the node node2, node2 is abnormally powered off and does not clear the use(peer) tag, when the node node1 loads the storage pool vd2, the use(peer) tag is read at first, and is found to be 1, use(peer) is read again after a delay of a certain period of time, if it is found that the keep-alive timestamp does not change and use(peer) is still 1, it is indicated that node2 is not alive, use(me) is written to be 1, whether use(me) is successfully written or not is checked, use(peer) is read at the same time, if use(peer) is 1 and the keep-alive timestamp changes, it is indicated that split-brain occurs, node2 is required to load the storage pool vd2, and the node node1 clears the use(me) tag and does not load the storage pool vd2.

In the present embodiment, reading use(peer) for many times may accurately judge whether a split-brain state occurs or not, so that split-brain state detection cost is reduced, and detection reliability is improved.

In certain embodiments, an implementation device diagram is further provided. For example, in a double-controller system, the alternative device diagram includes: a reading module, a judgment module, a writing module and a loading module.

The reading module includes a first reading unit and a second reading unit, the first reading unit is configured to read a use(me) value, and the second reading unit is configured to read a use(peer) value.

The writing module includes a writing unit, configured to write the use(me) value.

The judgment module includes a judgment unit, configured to judge whether split-brain currently occurs or not according to the read use(me) and use(peer) values, and the judgment module and the reading module may exist as one module.

The loading module includes a loading unit, and whether a resource is loaded or not is determined according to a result of the judgment unit, and the loading module and the writing module may exist as one module.

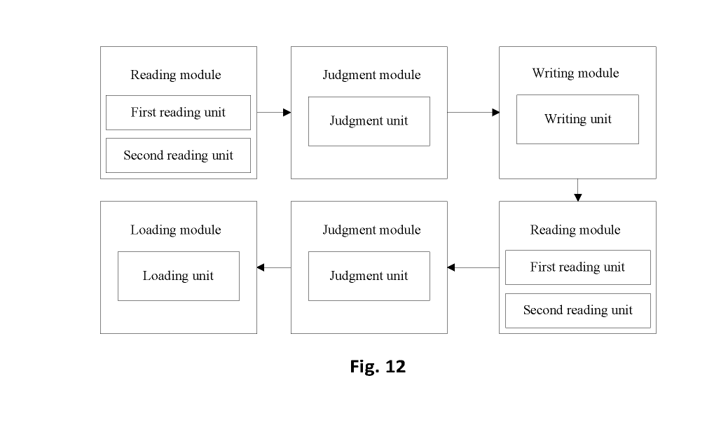

FIG. 12 is a module using flowchart of split-brain detection with a structure block diagram of a resource processing device for a double-controller system according to an alternative embodiment of the present disclosure. As shown in FIG. 12, in a specific implementation process, the second reading unit in the reading module reads an indication tag use(peer) which indicates whether node2 loads vd2 or not, and the judgment unit in the judgment module judges that node2 does not load vd2 according to a value 1 of use(me) read by the second reading unit. Then, the writing unit in the writing module writes use(me) in vd2 to be 1, the first reading unit in the reading module reads whether use(me) is successfully written or not, the second reading unit reads that the value of use(peer) does not change and a timestamp also does not change, the judgment unit in the judgment module judges that node2 actually does not load vd2, and then the loading unit in the loading module loads vd2.

By virtue of each device, the resource processing method for the double-controller system may be combined to judge whether the split-brain state occurs or not, so that the split-brain detection cost is reduced, and the detection reliability is improved.

The above are only the exemplary embodiments of the present disclosure and not intended to limit the present disclosure. For those skilled in the art, the present disclosure may have various modifications and variations. Any modifications, equivalent replacements, improvements and the like hall fall within the scope of protection of the present disclosure.

1. A resource processing method for a multi-controller system, comprising:
a controller in the multi-controller system cannot sense existence of a peer controller in the multi-controller system; and
judging, by the controller, whether the peer controller loads a first resource pool according to a first use tag stored in the first resource pool previously loaded by the peer controller, wherein the first use tag identifying whether the peer controller loads the first resource pool or not.

2. The method as claimed in claim 1, wherein, before judging, by the controller, whether the peer controller loads the first resource pool according to the first use tag, the method further comprises:
writing, by each controller in the multi-controller system, the first use tag into a respectively loaded resource pool at regular intervals, wherein the first use tag identifying whether the controller loads the resource pool of the controller or not.

3. The method as claimed in claim 1, wherein, under the condition that the controller judges that the peer controller does not load the first resource pool according to the first use tag, the method further comprises:
writing, by the controller, a second use tag indicating the controller to load the first resource pool into the first resource pool, and loading the first resource pool.

4. The method as claimed in claim 3, wherein, after writing, by the controller, the second use tag indicating the controller to load the first resource pool into the first resource pool, the method further comprises:
judging, by the controller, whether the peer controller loads the first resource pool according to the first use tag in the first resource pool, and under the condition that the peer controller loads the first resource pool, not loading, by the controller, the first resource pool, and clearing the second use tag.

5. The method as claimed in claim 1, wherein judging, by the controller, whether the peer controller loads the first resource pool or not according to the first use tag stored in the first resource pool comprises:
under the condition that the first use tag comprises identification information indicating whether the controller loads the resource pool, determining, by the controller, whether the peer controller loads the first resource pool according to a value of the identification information; and/or,
under the condition that the first use tag comprises the identification information indicating whether the controller loads the resource pool and writes a timestamp of the identification information, judging, by the controller, whether the timestamp changes within a preset time length, determining that the peer controller loads the first resource pool if the timestamp changes, otherwise determining that the peer controller does not load the first resource pool.

6. The method as claimed in claim 1, wherein regularly writing, by each controller, the first use tag into the respectively loaded resource pool comprises:
writing, by each controller, the first use tag into a corresponding logic area in the respectively loaded resource pool, wherein the resource pool is logically divided into n areas, each area corresponds to a controller, and the first use tag written into each area represents a resource pool loading condition of the controller corresponding to the area.

7. A resource processing device for a multi-controller system, located in a controller, the device comprising:
a sensing module, configured to sense whether a peer controller exists or not; and
a judgment module, configured to, under the condition that the sensing module cannot sense existence of the peer controller, judge whether the peer controller loads a first resource pool or not according to a first use tag stored in the first resource pool previously loaded by the peer controller.

8. The device as claimed in claim 7, wherein the device further comprises:
a first writing module, configured to write the first use tag into the resource pool loaded by the controller at regular intervals, wherein the first use tag identifying whether the controller loads the resource pool of the controller or not.

9. The device as claimed in claim 7, wherein the device further comprises:
a second writing module, configured to, under the condition that the judgment module judges that the peer controller does not load the first resource pool, write a second use tag indicating the controller to load the first resource pool into the first resource pool, and load the first resource pool.

10. The device as claimed in claim 9, wherein
the second writing module is further configured to, after the second use tag is written, judge whether the peer controller loads the first resource pool according to the first use tag in the first resource pool, and under the condition that a judgment result is the peer controller loads the first resource pool, not load the first resource pool and clear the second use tag.

11. The device as claimed in claim 7, wherein the judgment module comprises:
a first judgment unit, configured to, under the condition that the first use tag comprises identification information indicating whether the controller loads the resource pool, determine whether the peer controller loads the first resource pool according to a value of the identification information; and/or,
a second judgment unit, configured to, under the condition that the first use tag comprises the identification information indicating whether the controller loads the resource pool and writes a timestamp of the identification information, judge whether the timestamp changes or not within a preset time length, determine that the peer controller loads the first resource pool if the timestamp changes, otherwise determine that the peer controller does not load the first resource pool.

12. The device as claimed in claim 8, wherein the first writing module comprises:
a logic module, configured to write the first use tag into a corresponding logic area in the resource pool loaded by the controller, wherein the resource pool is logically divided into n areas, each area corresponds to a controller, and the first use tag written into each area represents a resource pool loading condition of the controller corresponding to the area.

13. The method as claimed in claim 3, wherein judging, by the controller, whether the peer controller loads the first resource pool or not according to the first use tag stored in the first resource pool comprises:
under the condition that the first use tag comprises identification information indicating whether the controller loads the resource pool, determining, by the controller, whether the peer controller loads the first resource pool according to a value of the identification information; and/or,
under the condition that the first use tag comprises the identification information indicating whether the controller loads the resource pool and writes a timestamp of the identification information, judging, by the controller, whether the timestamp changes within a preset time length, determining that the peer controller loads the first resource pool if the timestamp changes, otherwise determining that the peer controller does not load the first resource pool.

14. The method as claimed in claim 4, wherein judging, by the controller, whether the peer controller loads the first resource pool or not according to the first use tag stored in the first resource pool comprises:
under the condition that the first use tag comprises identification information indicating whether the controller loads the resource pool, determining, by the controller, whether the peer controller loads the first resource pool according to a value of the identification information; and/or,
under the condition that the first use tag comprises the identification information indicating whether the controller loads the resource pool and writes a timestamp of the identification information, judging, by the controller, whether the timestamp changes within a preset time length, determining that the peer controller loads the first resource pool if the timestamp changes, otherwise determining that the peer controller does not load the first resource pool.

15. The method as claimed in claim 3, wherein regularly writing, by each controller, the first use tag into the respectively loaded resource pool comprises:
writing, by each controller, the first use tag into a corresponding logic area in the respectively loaded resource pool, wherein the resource pool is logically divided into n areas, each area corresponds to a controller, and the first use tag written into each area represents a resource pool loading condition of the controller corresponding to the area.

16. The method as claimed in claim 4, wherein regularly writing, by each controller, the first use tag into the respectively loaded resource pool comprises:
writing, by each controller, the first use tag into a corresponding logic area in the respectively loaded resource pool, wherein the resource pool is logically divided into n areas, each area corresponds to a controller, and the first use tag written into each area represents a resource pool loading condition of the controller corresponding to the area.

17. The device as claimed in claim 9, wherein the judgment module comprises:
a first judgment unit, configured to, under the condition that the first use tag comprises identification information indicating whether the controller loads the resource pool, determine whether the peer controller loads the first resource pool according to a value of the identification information; and/or,
a second judgment unit, configured to, under the condition that the first use tag comprises the identification information indicating whether the controller loads the resource pool and writes a timestamp of the identification information, judge whether the timestamp changes or not within a preset time length, determine that the peer controller loads the first resource pool if the timestamp changes, otherwise determine that the peer controller does not load the first resource pool.

18. The device as claimed in claim 10, wherein the judgment module comprises:
a first judgment unit, configured to, under the condition that the first use tag comprises identification information indicating whether the controller loads the resource pool, determine whether the peer controller loads the first resource pool according to a value of the identification information; and/or,
a second judgment unit, configured to, under the condition that the first use tag comprises the identification information indicating whether the controller loads the resource pool and writes a timestamp of the identification information, judge whether the timestamp changes or not within a preset time length, determine that the peer controller loads the first resource pool if the timestamp changes, otherwise determine that the peer controller does not load the first resource pool.

19. The device as claimed in claim 9, wherein the first writing module comprises:
a logic module, configured to write the first use tag into a corresponding logic area in the resource pool loaded by the controller, wherein the resource pool is logically divided into n areas, each area corresponds to a controller, and the first use tag written into each area represents a resource pool loading condition of the controller corresponding to the area.

20. The device as claimed in claim 10, wherein the first writing module comprises:
a logic module, configured to write the first use tag into a corresponding logic area in the resource pool loaded by the controller, wherein the resource pool is logically divided into n areas, each area corresponds to a controller, and the first use tag written into each area represents a resource pool loading condition of the controller corresponding to the area.
